(19) United States
(12) Patent Application Publication
(10) Pub. No.: US 2003/0221311 A1
(43) Pub. Date: Dec. 4, 2003

(54) Fuel cell assembly and sealing

(76) Inventors: Jeffrey A. Smith, Brighton, MI (US); Michael Moore, Canton, MI (US); Steven Haycock, Northville, MI (US)

Correspondence Address: MACMILLAN SOBANSKI & TODD, LLC, ONE MARITIME PLAZA FOURTH FLOOR, 720 WATER STREET, TOLEDO, OH, 43604-1619, US

(21) Appl. No.: 10/392,554

(22) Filed: Mar. 20, 2003

Related U.S. Application Data
(60) Provisional application No. 60/365,928, filed on Mar. 20, 2002.

(51) Int. Cl. H01M 2/08; H01M 4/88

(52) U.S. Cl. 29/623.2; 502/101

(57) ABSTRACT

A method of assembling the components of a membrane electrode sealed assembly is disclosed. The method includes employing at least one roll with cell sections in order to allow for better alignment of the cell sections of the component layers. Preferably an adhesive is pre-coated onto gasket layers, with the adhesive activated after assembly of the component layers in order to secure the membrane electrode sealed assembly together. The membrane electrode sealed assembly can then be assembled between separator plates to form an individual cell of a fuel cell assembly.

### CROSS REFERENCE TO RELATED APPLICATIONS

This clams the benefit of U.S. provisional patent application identified as Application No. 60/365,928, filed Mar. 20, 2002.

### BACKGROUND OF INVENTION

This invention relates in general to methods of assembly static seals to mating parts, and more particularly to a method for assembling gaskets and other components employed in a fuel cell.

A fuel cell is an electrochemical energy converter that includes two electrodes placed on opposite surfaces of an electrolyte. In one form, an ion-conducting polymer electrolyte membrane is disposed between two electrode layers to form a membrane electrode assembly (MEA). The MEA is used to promote a desired electrochemical reaction from two reactants. One reactant, oxygen or air, passes over one electrode while hydrogen, the other reactant, passes over the other electrode. The oxygen and hydrogen combine to produce water, and in the process generate electricity and heat.

An individual cell within a fuel cell assembly includes a MEA placed between a pair of separator plates. The separator plates are typically fluid impermeable and electrically conductive. Fluid flow passages or channels are formed adjacent to each plate surface at an electrode layer to facilitate access of the reactants to the electrodes and the removal of the products of the chemical reaction. In such fuel cells, resilient gaskets or seals are typically provided between the faces of the MEA and the perimeter of each separator plate to prevent leakage of the fluid reactant and product streams. Since the fuel cell operates with oxygen and hydrogen, it is important to provide a seal that not only seals well against hydrogen, oxygen and water, but that will seal well as the temperature changes due to the heat that is given off during fuel cell operation.

Moreover, in order to assure a good seal and a properly operable fuel cell, the seals and other components in the MEA need to be formed accurately as well as aligned properly with each other. Also, it is desirable that the seal is formed and assembled to the other components with minimal waste material and contaminants that might interfere with the operation of the cell.

Unfortunately, the current methods of assembling the components involves cutting all of the components to final size before any assembly takes place. Then, all of the individual components must be very carefully aligned and stacked. All of the layers of the MEA are very thin and difficult to handle, some layers are relatively easily damaged when handled, and some produce loose fibers while being handled that can end up contaminating a finished assembly, so it is desirable to handle them less than this assembly method requires. Further, this type of method, by employing stacks of pre-cut components, can allow the components to possibly wrinkle, warp, bend, or twist, thus making proper alignment during assembly more difficult. In addition, because full coverage of the active area of the cell by both gas diffusion layers is important, and alignment is difficult, the gas diffusion layers are being cut larger than is actually needed, and the active area may be made smaller than otherwise necessary, in order to assure this full coverage. But the material for the gas diffusion layers is very expensive, so the extra material increases the cost of each cell. And, a reduced active area reduces the fuel cell output.

Thus, it is desirable to be able to assemble a membrane electrode sealed assembly, for an individual cell of a fuel cell, that is relatively easy to accurately align, with minimal handling of the components, and while assuring the proper sealing and operation of the finished assembly.

### SUMMARY OF INVENTION

In its embodiments, the present invention contemplates a method for assembling a membrane electrode sealed assembly, the method comprising the steps of: unrolling a first cell section from a first gasket roll; aligning a first cell section of a first gas diffusion layer with the first cell section of the first gasket roll; aligning a first cell section of a membrane layer with the first cell section of the first gas diffusion layer; aligning a first cell section of a second gas diffusion layer with the first cell section of the membrane layer; locating a first catalyst layer on one of the membrane layer and the first gas diffusion layer prior to the first cell section of the membrane layer being aligned with the first cell section of the first gas diffusion layer; locating a second catalyst layer on one of the second gas diffusion layer and the membrane layer prior to the first cell section of the second gas diffusion layer being aligned with the first cell section of the membrane layer; unrolling a first cell section from a second gasket roll; and aligning the first cell section from the second gasket roll with the first cell section of the second gas diffusion layer.

The present invention further contemplates a method for assembling a membrane electrode sealed assembly, the method comprising the steps of: orienting a first cell section from a first gasket layer; unrolling a first cell section of a first gas diffusion layer from a first gas diffusion layer roll; aligning the first cell section of the first gas diffusion layer with the first cell section of the first gasket layer; aligning a first cell section of a membrane layer with the first cell section of the first gas diffusion layer; unrolling a first cell section of a second gas diffusion,layer from a first gas diffusion layer roll; aligning the first cell section of the second gas diffusion layer with the first cell section of the membrane layer; locating a first catalyst layer on one of the membrane layer and the first gas diffusion layer prior to the first cell section of the membrane layer being aligned with the first cell section of the first gas diffusion layer; locating a second catalyst layer on one of the second gas diffusion layer and the membrane layer prior to the first cell section of the second gas diffusion layer being aligned with the first cell section of the membrane layer; and aligning a first cell section from a second gasket layer with the first cell section of the second gas diffusion layer.

The present invention additionally contemplates a method for assembling a membrane electrode sealed assembly, the method comprising the steps of: orienting a first cell section from a first gasket layer; aligning a first cell section of a first gas diffusion layer with the first cell section of the first gasket layer; unrolling a first cell section of a membrane layer from a membrane layer roll; aligning the first cell section of the membrane layer with the first cell section of the first gas diffusion layer; aligning a first cell section of a second gas diffusion layer with the first cell section of the membrane layer; locating a first catalyst layer on one of the membrane layer and the first gas diffusion layer prior to the first cell section of the membrane layer being aligned with the first cell section of the first gas diffusion layer; locating a second catalyst layer on one of the second gas diffusion layer and the membrane layer prior to the first cell section of the second gas diffusion layer being aligned with the first cell section of the membrane layer; and aligning a first cell section from a second gasket layer with the first cell section of the second gas diffusion layer.

An advantage of the present invention is that the assembly method for the membrane electrode sealed assembly, by employing components taken from rolls, allows for more accurate alignment. Being on rolls allows for a slight tension in the component materials, thus reducing concerns with wrinkling, warp, bend or twisting. Moreover, since accurate alignment is more repeatably obtained, the need for gas diffusion layer overlap is avoided, thus reducing the cost and/or increasing the active area of the cell.

Another advantage of the present invention is that assembling from the material rolls also, reduces the amount of handling for individual components prior to being assembled. This reduces the chances for damage of components during assembly, and reduces the amount of contaminants produced during assembly.

### BRIEF DESCRIPTION OF DRAWINGS

FIG. 1 is a schematic, plan view of an individual cell of a fuel cell assembly, assembled in accordance with a method of the present invention.

FIG. 2 is a section cut, on an enlarged scale, taken along line 2-2 in FIG. 1.

FIG. 3 is a section cut, similar to FIG. 2, but illustrating a different embodiment of an individual cell of a fuel cell assembly, prior to compressing separator plates onto a membrane electrode sealed assembly, assembled in accordance with a method of the present invention.

FIG. 4 is a schematic, plan view of a portion of a gasket roll, as is employed in an assembly method of the present invention.

FIG. 5 is a schematic view of a series of rolls from which the membrane electrode sealed assembly components are cut and aligned in order to form a membrane electrode sealed assembly, as assembled in accordance with a method of the present invention.

FIGS. 6a and 6b are portions of a flow chart illustrating an embodiment of an assembly method of the present invention.

FIG. 7 is a view similar to FIG. 5, but illustrating a first alternate set of rolls from which membrane electrode sealed assembly components are cut and aligned.

FIGS. 8a and 8b are portions of a flow chart illustrating a first alternate embodiment of the assembly method of FIGS. 6a and 6b.

### DETAILED DESCRIPTION

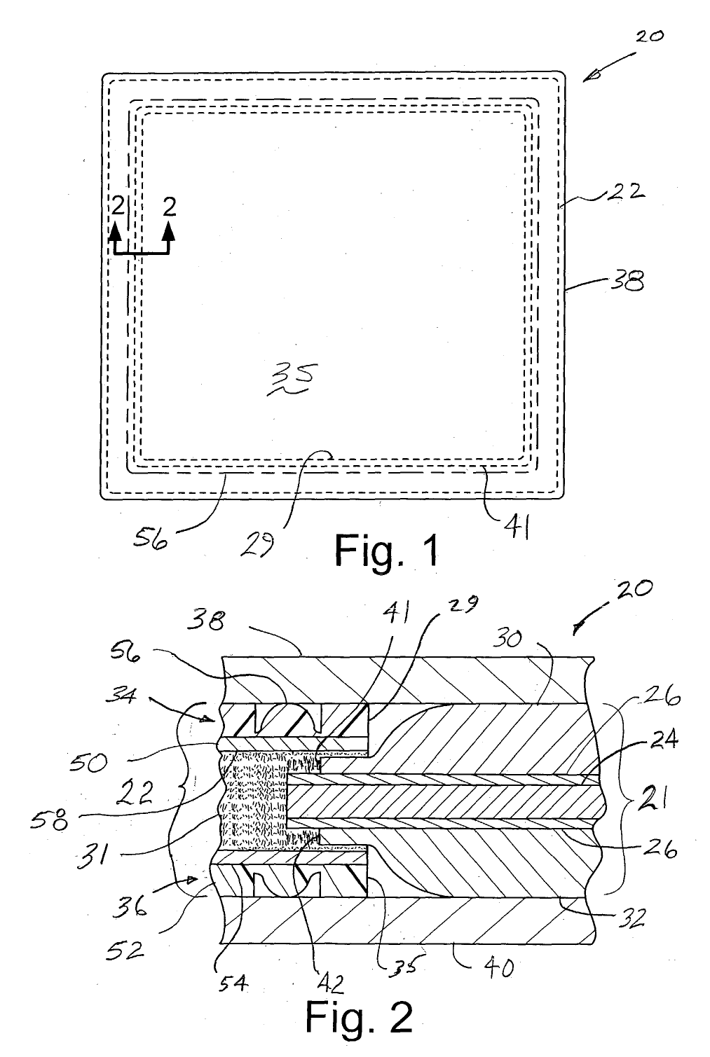

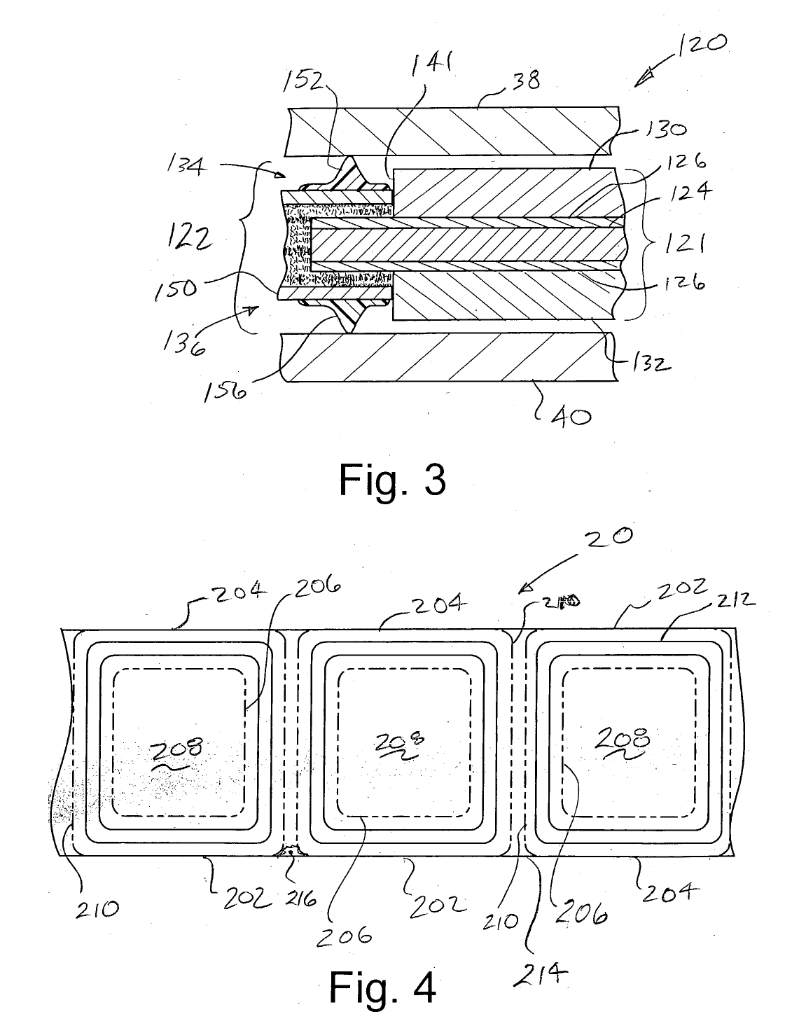

FIGS. 1-2 illustrate an individual cell 20 for use in a fuel cell assembly. The individual cell 20 includes a membrane electrode assembly (MEA) 21, that is formed as part of a membrane electrode sealed assembly 22. The MEA 21 is made up of a membrane 24, with a layer of catalyst material 26 on both sides of the membrane 24. The MEA 21 also includes a first gas diffusion layer (GDL) 30 and second GDL 32 on either side of the layers of catalyst material 26. With a first gasket 34 and a second gasket 36 secured around the perimeters 41, 42 of the first GDL 30 and the second GDL 32—preferably, the gaskets 34, 36 are secured to the GDLs 30, 32 by adhesive 31—a membrane electrode sealed assembly 22 is formed. Each gasket 34, 36 includes an inner perimeter 29, which defines an active area 35. Preferably, the adhesive 31 extends around and seals the entire edge of the MEA 21. A first separator plate 38 mounts against the first gasket 34, and against the first GDL 30 in the active area 35. A second separator plate 40 mounts against the second gasket 36, and against the second GDL 32 in the active area 35. The separator plates 38, 40 assembled to the membrane electrode sealed assembly 22 essentially form the individual cell 20.

Since the thicknesses of the various components are very thin, they are only depicted schematically in the figures in order to aid in describing the invention. The actual thicknesses of each of the components will vary according to the particular application of the fuel cell and are known to those skilled in the art.

The membrane 24 is preferably an ion-conducting, polymer, electrolyte membrane, as generally employed in this type of fuel cell application. The catalyst material 26 is preferably platinum or other suitable catalyst material for a typical polymer electrode membrane type of fuel cell application. The first and second GDLs 30, 32 are preferably a carbonized fiber, or may be another suitable gas permeable material for use as an electrode in a fuel cell. The MEA 22 can include a catalyzed membrane with GDLs assembled thereto, or a membrane assembled between two catalyzed GDLs, or a combination of the two, each of which is known to those skilled in the art. The first and second separator plates 38, 40 are generally rectangular in shape, although other shapes can also be employed if so desired. The plates 38, 40 have outer surfaces that are made to mate with adjoining individual cells in order to make up a completed fuel cell assembly. The adhesive is preferably one that is activated by some external source, such as pressure, heat, or ultraviolet light—although, other types of adhesive may be employed instead, if so desired.

Each gasket 34, 36 preferably has a gasket carrier 50, with an elastomeric seal 52 molded to a first side 54. The carrier 50 is preferably a thin, flexible member, and may be made of a polymeric material, such as, for example, polyester, polyimid, or nylon. The elastomeric seal 52 is preferably made of an elastomeric material with good sealing properties, such as, for example, rubber. The seal 52 may include a sealing bead 56 protruding therefrom, if so desired, as is known in the art. An advantage of having multi-component gaskets 34, 36 is that it is easy for the carriers 50 to have the adhesive 31 pre-applied to a second side 58 prior to assembly of the membrane electrode sealed assembly 22.

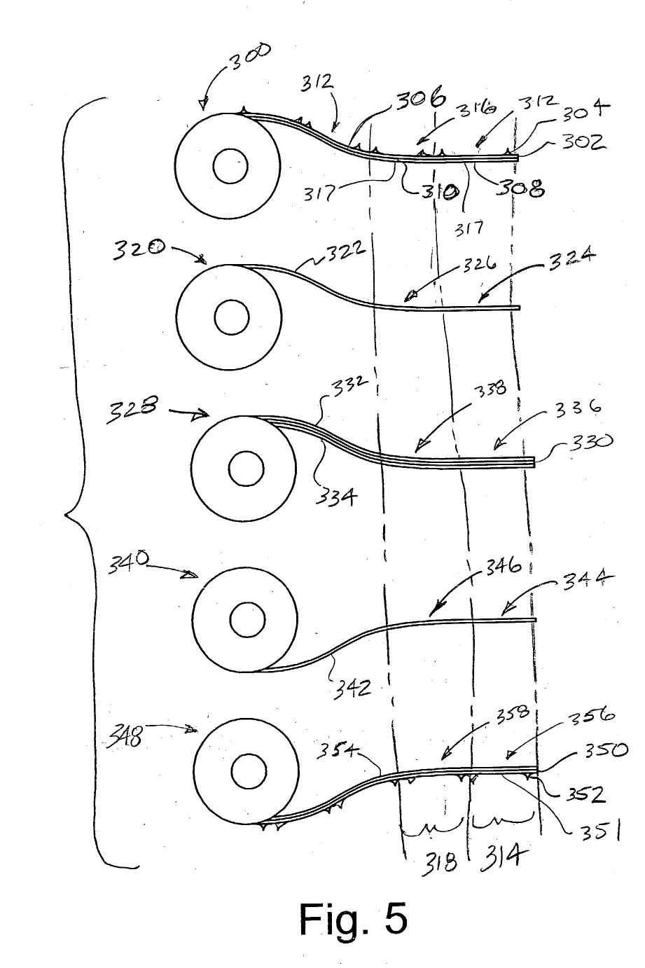

FIG. 3 illustrates a second embodiment of an individual cell 120 assembled with an assembly method of the present invention. In this figure, elements that are the same as FIG. 2 will retain the same element number, while changed or added elements will have a 100-series number. FIG. 3 illustrates the components of an individual cell 120, but just prior to compressing the separator plates 38, 40 against the membrane electrode sealed assembly 122. In this embodiment, the MEA 121 is different in that the perimeters 141 of the gas diffusion layers 130, 132 are adjacent to but do not overlap with the gaskets 134, 136, while the membrane 124 and catalyst layers 126 still overlap with the gaskets 134, 136. Also the elastomeric seals 152, mounted on the carriers 150, are shaped differently, providing a different sealing bead 156. Still, this embodiment of an individual cell 120, as with other similar types of embodiments of individual cells, can be assembled with the improved methods of assembly of the present invention.

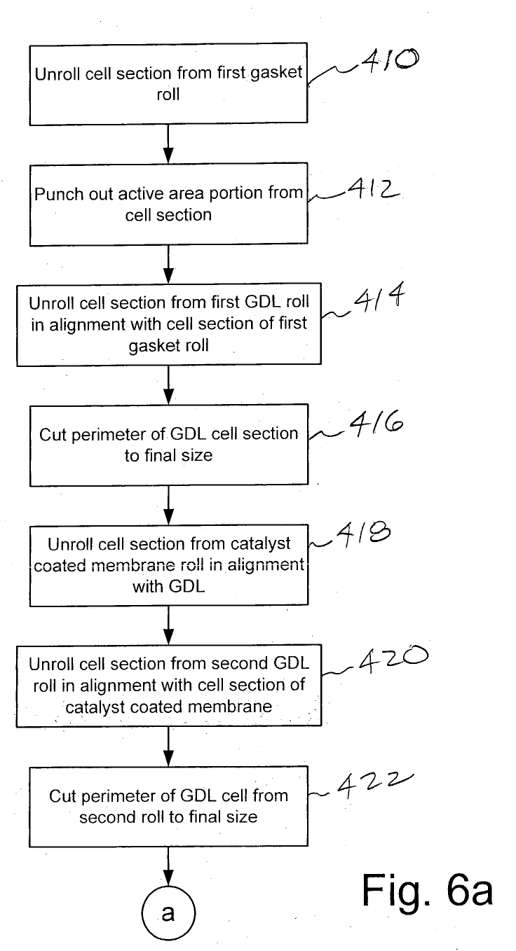

FIG. 4 illustrates a portion of a first gasket roll 200, with a series of cell sections 202 that can be cut to form gaskets 204. An interior phantom line 206 shown in each cell section 202 indicates a cut line which, after removal, will create the boundaries for active areas 208 in each cell section. Exterior phantom lines 201 shown around each cell section 202 indicate cut lines for forming the exterior perimeter of each gasket, preferably being cut after assembly. Preferably, an elastomeric seal 212 is already molded onto a carrier 214 prior to creating the gasket roll 200. Also, preferably, an adhesive 216 is already coated on the opposite side of the carrier 214 prior to creating the gasket roll 200. Alternatively, the adhesive layer can be added during the process of assembling the various layers, but that may complicate the stacking and alignment process.

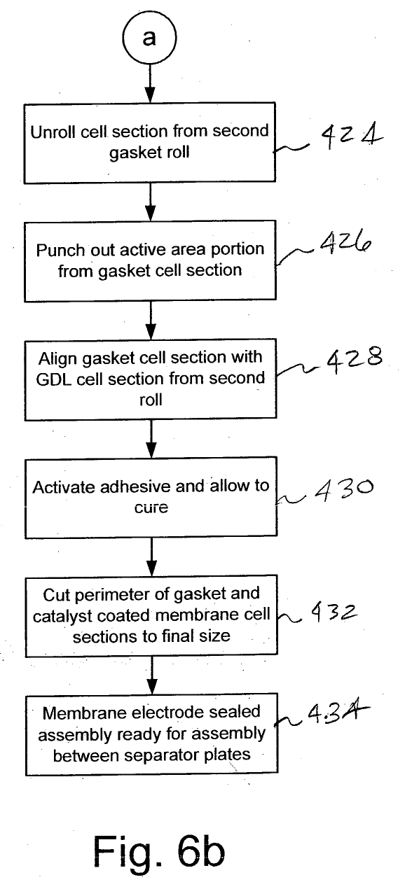

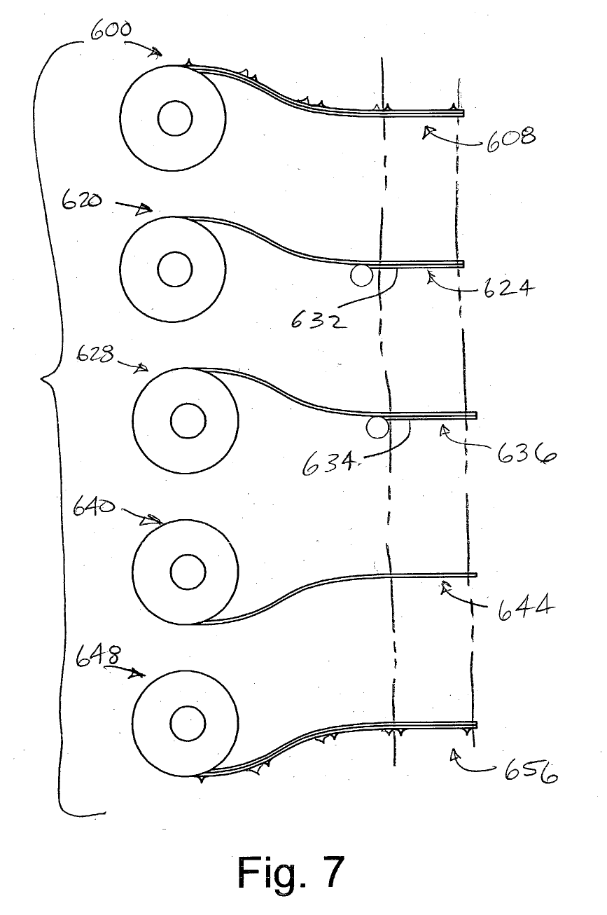

FIG. 5 illustrates rolls of the various components that can be assembled using the assembly method shown in FIGS. 6a and 6b. A first gasket roll 300 preferably comes off in a single sheet that includes a carrier layer 302, with elastomeric seals 304 molded onto a first side 306 and an adhesive layer 308 applied to the second side 310. The gasket roll 300, when the time in the assembly step is reached, will then be cut during the formation of a first cell section 312 for a first membrane electrode sealed assembly 314, then for the formation of a second cell section 316 for a second membrane electrode sealed assembly 318, etc. Active areas 317 will also be cut from the first cell section 312, second cell section 316, etc. A first GDL roll 320 includes a single layer 322 that is unrolled, and can be cut prior to assembly with the first gasket roll 300 (or after if preferred) in order to form a first cell section 324, a second cell section 326, etc.

A membrane roll 328 preferably comes off in a single sheet that includes a membrane layer 330, with a catalyst layer 332, 334 on either side. The membrane roll 328 can then be cut to form a first cell section 336, a second cell section 338, etc. As an alternative, the catalyst layers 332, 334 can be pre-applied to the GDL layers, rather than to the membrane layer 330, if so desired. A second GDL roll 340 is similar to the first and includes a single layer 342 that is unrolled and cut to form a first cell section 344, a second cell section 346, etc. A second gasket roll 348 includes a carrier layer 350, with elastomeric seals 352 molded onto a first side and an adhesive layer 354 applied to a second side. It is also cut at some step in the assembly process to form a first cell section 356, a second cell section 358;an active area 351, etc.

While the all of the rolls of component material are shown oriented in the same direction, they can, of course be oriented however one wishes in order to best utilize the factory space where the assembly is taking place. Different types of rollers and other tools (not shown) can then be employed to assure the desired tension in the various layers as they are being oriented, aligned, cut, etc.

The various component layers shown in FIG. 5 can be assembled employing an assembly process of the present invention, such as that illustrated in FIGS. 6a and 6b.

FIGS. 6a and 6b illustrate an assembly method for assembling a membrane electrode sealed assembly. A cell section 312 is unrolled from a first gasket roll 300, block 410. The active area 317 for this first cell section 312 is punched out, block 412. A cell section 324 from the first GDL roll 320 is aligned with the cell section 312, block 414. The perimeter of the GDL cell section 324 is then cut to its final size, block 416. A cell section 336 from the catalyst coated membrane roll 328 is aligned with the cell section 324, block 418. A cell section 344 of the second GDL roll 340 is aligned with the cell section 336, block 420. The perimeter of the cell section 344 is then cut to its final size, block 422. A cell section 356 is unrolled from a second gasket roll 348, block 424, and the active area portion 351 is punched out from the cell section 356, block 426. The cell section 356 is aligned with the cell section 344 from the second GDL roll 340, block 428. Now that the component layers are stacked and aligned properly, the adhesive is activated in order to allow it to flow and cure, block 430. As discussed above, the adhesive can then act to hold the layers of the membrane electrode sealed assembly together and seal about the perimeter. The perimeter of the cell sections is then cut to final size, block 432. The membrane electrode sealed assembly is now ready for assembly between separator plates (not shown in these figures), block 434, in order to form an individual cell of a fuel cell assembly.

Where tension is desired during the alignment process in order to minimize wrinkles and twisting, the particular component layer may be left uncut from the roll. The roll can then be used to maintain the desired tension until the proper alignment is secured, after which, the particular cell section is cut from the particular roll.

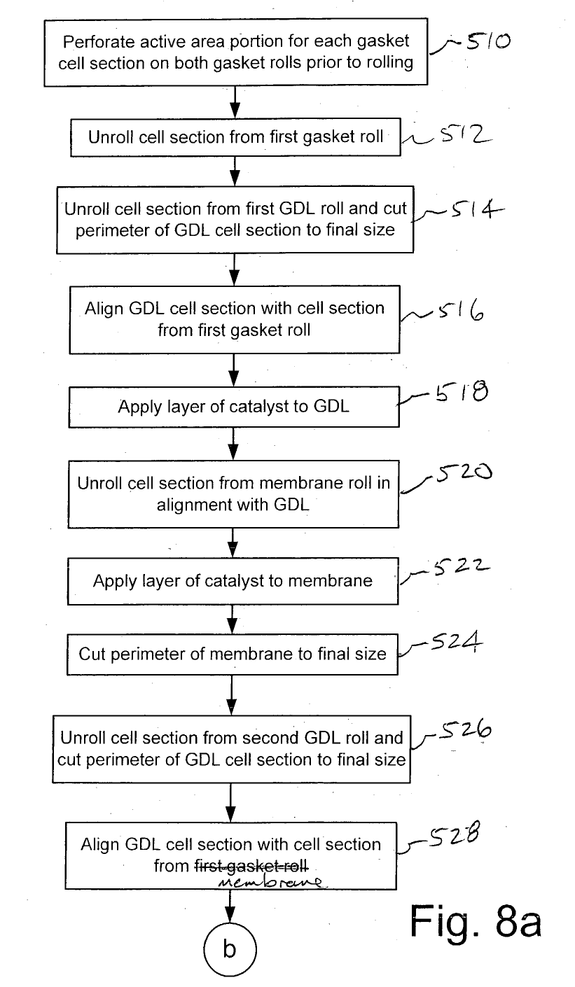

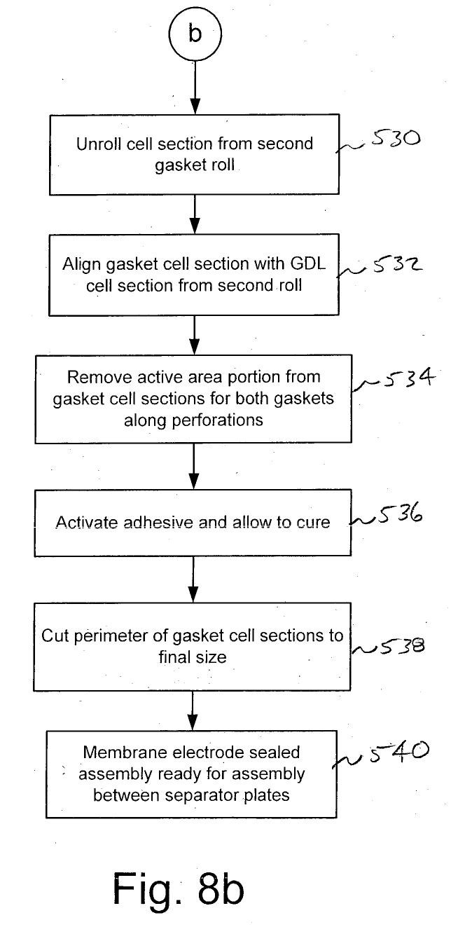

FIG. 7 illustrates an alternative embodiment of the component rolls shown in FIG. 5, which can be assembled using the assembly method shown in FIGS. 8a and 8b. In this embodiment, elements that are similar to those in FIG. 5 will have the same general reference number, except they will be 600-series numbers. The first gasket roll 600, with its cell section 608, the second GDL roll 640, with its cell section 644, and the second gasket roll 648, with its cell section 656, are essentially the same as in the embodiment of FIG. 5. In this embodiment, however, the first catalyst layer 632 is applied to the GDL roll 620 as it comes off of the roll, thus forming a different cell section 624, which is catalyst coated. This coating is preferably rolled-on, but other methods of application may also be employed if so desired. Also, the membrane roll 628 does not include any catalyst material when pulled from the roll. Rather a second layer of catalyst material 634 is applied as the membrane comes off of the roll. This forms a different cell section 636 than the one in FIG. 5. As an alternative, the catalyst layer 634 can be applied to the second GDL roll 640 rather than the membrane 628, if so desired.

FIGS. 8a and 8b illustrate an alternative embodiment of the assembly method illustrated in FIGS. 6a and 6b. This method includes the steps of perforating an active area portion for each gasket cell section on both rolls prior to rolling, block 510, and unrolling a cell section!from the first gasket roll, block 512. A cell section from the first GDL roll is unrolled and the perimeter is cut to final size, block 514, before aligning the cell section of the first GDL with the cell section of the first gasket roll, block 516. A first layer of catalyst material is applied to the cell section of the first GDL roll, block 518, and a cell section from a membrane roll is unrolled in alignment with the GDL, block 520. A second layer of catalyst is applied to the membrane cell section, block 522, and the perimeter of the membrane is cut to its final size, block 524. A cell section from the second GDL is unrolled and the perimeter of this cell section is cut to its final size, block 526, before aligning with the membrane, block 528, and the cell section from the second gasket is unrolled, block 530, and aligned with the cell section from the second GDL roll, block 532. The active area portion is then removed from both gaskets, along the perforations, block 534, and then the adhesive is activated and cures, block 536. The perimeter of the gasket cell sections are cut to final size, block 538 and the membrane electrode sealed assembly is ready to be assembled between separator plates, block 540.

Of course, since several of the steps of FIGS. 8a and 8b are different than the steps of 6a and 6b, many of the different steps can be applied in different combinations between the two illustrated embodiments in order to achieve the final assembled membrane electrode sealed assembly.

While certain embodiments of the present invention have been described in detail, those familiar with the art to which this invention relates will recognize various alternative designs and embodiments for practicing the invention as defined by the following claims.

What is claimed is:

1. A method for assembling a membrane electrode sealed assembly, the method comprising the steps of:
unrolling a first cell section from a first gasket roll;
aligning a first cell section of a first gas diffusion layer with the first cell section of the first gasket roll;
aligning a first cell section of a membrane layer with the first cell section of the first gas diffusion layer;
aligning a first cell section of a second gas diffusion layer with the first cell section of the membrane layer;
locating a first catalyst layer on one of the membrane layer and the first gas diffusion layer prior to the first cell section of the membrane layer being aligned with the first cell section of the first gas diffusion layer;
locating a second catalyst layer on one of the second gas diffusion layer and the membrane layer prior to the first cell section of the second gas diffusion layer being aligned with the first cell section of the membrane layer;
unrolling a first cell section from a second gasket roll; and
aligning the first cell section from the second gasket roll with the first cell section of the second gas diffusion layer.

2. The method of claim 1 further including the step of applying a first adhesive layer to a surface of the first cell section of the first gasket roll prior to aligning the first cell section of the first gas diffusion layer with the first cell section of the first gasket roll.

3. The method of claim 2 further including the steps of applying a second adhesive layer to a surface of the first cell section of the second gasket roll prior to aligning the first cell section of the second gas diffusion layer with the first cell section of the second gasket roll.

4. The method of claim 3 further including the step of activating the first and the second adhesive layer to thereby secure the first cell sections from the first gasket roll, the first gas diffusion layer, the membrane layer, the second gas diffusion layer and the second gasket roll together.

5. The method of claim 4 further including the step of cutting a perimeter of the first cell sections from the first gasket roll and the second gasket roll.

6. The method of claim 1 further including the step of removing an active area portion from the first cell section of the first gasket roll prior to aligning the first cell section of the first gas diffusion layer with the first cell section of the first gasket roll.

7. The method of claim 1 further including the step of cutting a perimeter of the first cell section of the first gas diffusion layer prior to aligning the first cell section of the first gas diffusion layer with the first cell section of the first gasket roll.

8. The method of claim 1 further including the step of cutting a perimeter of the first cell section of the first gas diffusion layer after aligning the first cell section of the first gas diffusion layer with the first cell section of the first gasket roll.

9. The method of claim 1 further including the step of unrolling the first cell section of the first gas diffusion layer from a first gas diffusion layer roll prior to aligning the first cell section of the first gas diffusion layer with the first cell section of the first gasket roll.

10. The method of claim 1 further including the step of unrolling the first cell section of the membrane layer from a membrane layer roll prior to aligning the first cell section of the membrane layer with the first cell section of the first gas diffusion layer.

11. The method of claim 10 further including the step of unrolling the first cell section of the second gas diffusion layer from a second gas diffusion layer roll prior to aligning the first cell section of the second gas diffusion layer with the first cell section of the membrane layer.

12. The method of claim 9 further including the step of unrolling the first cell section of the second gas diffusion layer from a second gas diffusion layer roll prior to aligning the first cell section of the second gas diffusion layer with the first cell section, of the membrane layer.

13. The method of claim 1 further including perforating an active area in the first cell section of the first gasket roll prior to aligning the first cell section of the first gas diffusion layer with the first cell section of the firs gasket roll.

14. The method of claim 13 further including the step of removing the active area from the first cell section of the first gasket roll after aligning the first cell section of the first gas diffusion layer with the first cell section of the firs gasket roll.

15. A method for assembling a membrane electrode sealed assembly, the method comprising the steps of:
orienting a first cell section from a first gasket layer;
unrolling a first cell section of a first gas diffusion layer from a first gas diffusion layer roll;
aligning the first cell section of the first gas diffusion layer with the first cell section of the first gasket layer;
aligning a first cell section of a membrane layer with the first cell section of the first gas diffusion layer;
unrolling a first cell section of a second gas diffusion layer from a first gas diffusion layer roll;
aligning the first cell section of the second gas diffusion layer with the first cell section of the membrane layer;
locating a first catalyst layer on one of the membrane layer and the first gas diffusion layer prior to the first cell section of the membrane layer being aligned with the first,cell section of the first gas diffusion layer;
locating a second catalyst layer on one of the second gas diffusion layer and the membrane layer prior to the first cell section of the second gas diffusion layer being aligned with the first cell section of the membrane layer; and
aligning a first cell section from a second gasket layer with the first cell section of the second gas diffusion layer.

16. The method of claim 15 further including the step of unrolling the first cell section of the membrane layer from a membrane layer roll prior to aligning the first cell section of the membrane layer with the first cell section of the first gas diffusion layer.

17. The method of claim 15 further including the step of applying a first adhesive layer to a surface of the first cell section of the first gasket layer prior to aligning the first cell section of the first gas diffusion layer with the first cell section of the first gasket layer.

18. The method of claim 17 further including the steps of applying a second adhesive layer to a surface of the first cell section of the second gasket layer prior to aligning the first cell section of the second gas diffusion layer with the first cell section of the second gasket layer.

19. The method of claim 18 further including the step of activating the first and the second adhesive layer to thereby secure the first cell sections from the first gasket layer, the first gas diffusion layer, the membrane layer, the second gas diffusion layer and the second gasket layer together.

20. A method for assembling a membrane electrode sealed assembly, the method comprising the steps of:
orienting a first cell section from a first gasket layer;
aligning a first cell section of a first gas diffusion layer with the first cell section of the first gasket layer;
unrolling a first cell section of a membrane layer from a membrane layer roll;
aligning the first cell section of the membrane layer with the first cell section of the first gas diffusion layer;
aligning a first cell section of a second gas diffusion layer with the first cell section of the membrane layer;
locating a first catalyst layer on one of the membrane layer and the first gas diffusion layer prior to the first cell section of the membrane layer being aligned with the first cell section of the first gas diffusion layer;
locating a second catalyst layer on one of the second gas diffusion layer and the membrane layer prior to the first cell section of the second gas diffusion layer being aligned with the first cell section of the membrane layer; and
aligning a first cell section from a second gasket layer with the first cell section of the second gas diffusion layer.
